(19) United States
(12) Patent Application Publication
(10) Pub. No.: US 2005/0122405 A1
(43) Pub. Date: Jun. 9, 2005

(54) Digital cameras and methods using GPS/time-based and/or location data to provide scene selection, and dynamic illumination and exposure adjustment

(76) Inventors: James S. Voss, Fort Collins, CO (US); James W. Owens, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,871

(22) Filed: Dec. 9, 2003

(51) Int. Cl. H04N 5/232

(52) U.S. Cl. 348/211.2

(57) ABSTRACT

Digital cameras and methods that employ location and time data to automatically select and/or adjust stored profiles used when taking photographs at different geographic locations. The digital camera comprises a user interface that is coupled to processing circuitry. A plurality of predetermined profiles are stored in the camera. Firmware is configured to run on the processing circuitry and process geographic location and time data entered into the camera, such as by way of the user interface, for example, to select one or more profiles based upon the geographic location and time data that were entered.

### TECHNICAL FIELD

The present invention relates generally to digital cameras and methods.

### BACKGROUND

When using digital cameras, there are a finite number of illumination sources that are used. These are generally very common ones such as indoor lighting using fluorescent lights or a flash devices, for example, and daytime lighting, twilight lighting, and nighttime lighting, for example.

Because of the atmosphere, the actual color of daylight changes across the globe. For example, daylight at the equator is not the same in terms of color spectrum as daylight in Canada, for example. Current solution creates a single illumination profile for all the illumination sources stored in the camera and applies all of them regardless of geographic location. It would be desirable to improve upon this limiting conventional technique.

In addition, it would be desirable to have a digital camera that has menu selections that allow a user to predetermine the type of scene that is to be photographed. This would allow parameters for photographing the scene to be more accurately determined. There are two known conventional solutions that provide this.

The first is that the camera simply does its best based on a number of parameters and tries to determine the scene. However, this technique is error prone. The second is that a user preselects the scene that is to be shot. This is much more accurate, but requires additional steps in the setup of the picture that is to be taken, which also adds complexity to the user interface of the camera.

However, the way that the camera currently determines a scene type is much more a process of elimination than it is a process of determination. For example, available scene types are “ruled out” until one scene type remains, which therefore “must be” the correct scene type, or several scene types are left and a guess is made as to which one it should be, but only after all extraneous scene types have been ruled out.

### SUMMARY OF THE INVENTION

The present invention comprises digital cameras and methods that employ location and time data to automatically select and/or adjust prestored profiles, such as scene parameters and illumination source profiles (exposure and color balance, for example) used when taking photographs at different geographic locations. One aspect of the present invention provides for the use of GPS data, or localization data entered into a digital camera by a user, to generate a better representation of illumination that should be used when taking photographs with the digital camera at a particular location. This aspect of the present invention uses one instantiation of GPS integration with a digital camera.

This aspect of the present invention involves selection of geographic location by a user where a photograph is to be taken using a menu system that is displayed on the camera. Based on that geographic location, one of a number of standard illumination sources stored in the camera is changed to have a more optimal illumination source profile using a different mathematical representation of the standard illumination source based upon the particular geographic location. This aspect of the present invention creates a better illumination source profile based on the specific geographic location where the picture is being taken.

Another aspect of the present invention minimizes or eliminates the need for the user to manually predetermine parameters for optimizing the photograph of a particular scene using the camera. The digital camera comprises prestored parameters for different scene types (scene profiles). By knowing the geographic location (either using GPS coordinates or manually entered coordinates or a location) and the time that the photograph is taken (again using GPS time or a manually entered time) firmware running on the camera can determine preferred parameters for the scene that is to be photographed.

Using the location and time information, the firmware eliminates those of the stored scene types (scene profiles) that are not appropriate for the location and/or time. The firmware then determines or selects an optimal scene profile and scene parameters from the remaining scene types or profiles that configure the digital camera.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are rear and front views, respectively, of an exemplary digital camera that may be used in a system in accordance with the principles of the present invention; and

FIG. 2 illustrates an exemplary method in accordance with the principles of the present invention.

### DETAILED DESCRIPTION

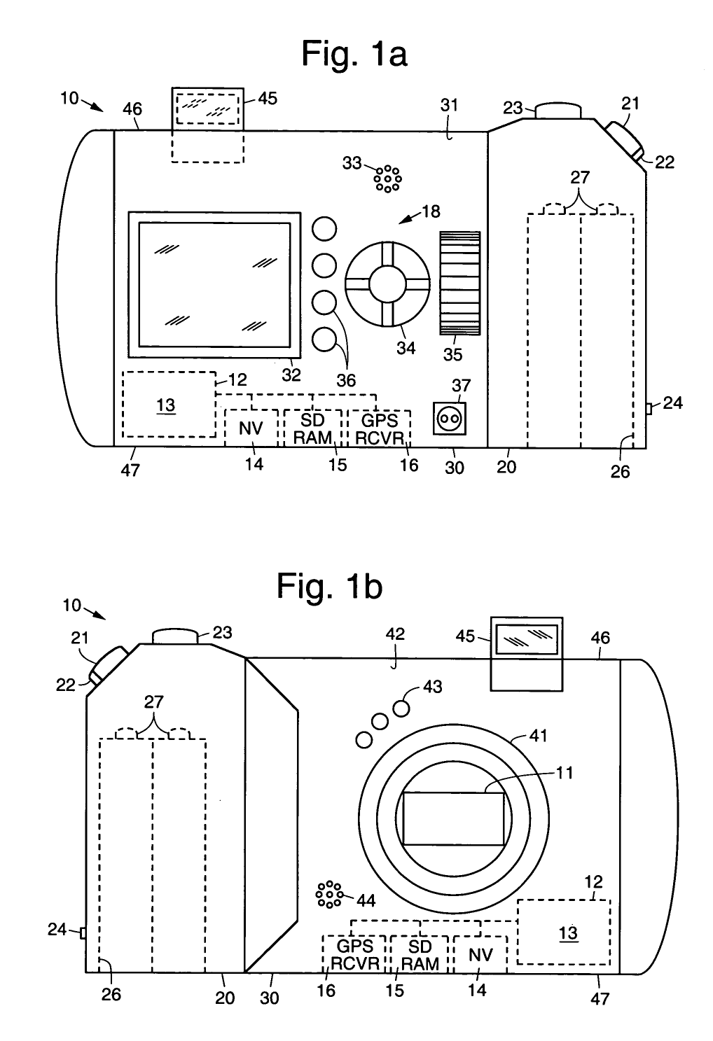

Referring to the drawing figures, FIGS. 1a and 1b are rear and front views, respectively, of an exemplary digital camera 10 implemented in accordance with the principles of the present invention. As is shown in FIGS. 1a and 1b, the exemplary digital camera 10 comprises a handgrip section 20 and a body section 30. The handgrip section 20 includes a power button 21 or switch 21 having a lock latch 22, a record button 23, a strap connection 24, and a battery compartment 26 for housing batteries 27. The batteries may be inserted into the battery compartment 26 through an opening adjacent a bottom surface 47 of the digital camera 10.

As is shown in FIG. 1a, a rear surface 31 of the body section 30 comprises a liquid crystal display (LCD) 32 or viewfinder 32, a rear microphone 33, a joystick pad 34, a zoom control dial 35, a plurality of buttons 36 for setting functions of the camera 10 and a video output port 37 for downloading images to a computer, for example. The display 32, joystick pad 34, and buttons 36 comprises a user interface 18 of the digital camera 10.

As is shown in FIG. 1b, a zoom lens 41 extends from a front surface 42 of the digital camera 10. A metering element 43 and front microphone 44 are disposed on the front surface 42 of the digital camera 10. A pop-up flash unit 45 is disposed adjacent a top surface 46 of the digital camera 10.

An image sensor 11 is coupled to processing circuitry 12 (illustrated using dashed lines) that are housed within the body section 30, for example. An exemplary embodiment of the processing circuitry 12 comprises a microcontroller (μC) 12 or central processing unit (CPU) 12. The processing circuitry 12 (μC 12 or CPU 12 is coupled to a nonvolatile (NV) storage device 14, and a high speed (volatile) storage device 15, such as synchronous dynamic random access memory (SDRAM) 15, for example. The processing circuitry 12 is also coupled to a GPS (global positioning system) receiver (GPS RCVR) 16 that receives position data (position coordinates) and time data from orbiting GPS satellites. The user interface 18 also allows manual entry of position and time data.

The digital camera 10 comprises prestored parameters for different scene profiles or scene types and illumination source profiles. The scene profiles define different predetermined exposure and scene type or profile settings for the camera 10, for example. Typical scene profiles include portrait, macro, and sports mode, for example. The illumination source profiles (exposure and color balance, for example) define different predetermined lighting effects that may be selectively applied to a recorded photograph.

The processing circuitry 12 (microcontroller (μC) 12 or CPU 12) in the digital camera 10, embodies firmware 13 comprising a software algorithm 13 in accordance with the principles of the present invention. The firmware 13 in conjunction with the GPS receiver 16 and user interface 18 implement the novel aspects of the present invention.

The firmware 13 is operative to automatically select and adjust scene parameters and illumination source profiles, based upon the specific geographic location and time that the photograph is to be taken.

One aspect of the firmware 13 generates an optimal representation of illumination that should be used when taking a photograph at a particular location based upon geographic location and time. For example, the geographic location is entered into the camera 10 by way of the GPS receiver 18 or manually by the user using a menu system of the user interface 18. Based on that geographic location, one of the prestored standard illumination sources is changed to a more optimal illumination source profile using a different or calculated mathematical representation of the standard illumination source. This aspect of the present invention creates a better illumination source profile based on the specific geographic location where the photograph is being taken.

This first aspect of the present invention thus provides for the use of GPS or localization data entered into a digital camera 10 by a user, to generate a better representation of illumination that should be used when taking photographs with the digital camera at a particular location. An advantage provided by the first aspect of the present invention is that better image quality through more accurate representations of the illumination sources based on geographic location.

Another aspect of the firmware 13 minimizes or eliminates manual user parameter determination for optimizing the photograph of a particular scene. As was mentioned above, the digital camera 10 comprises prestored parameters for different scene types (scene profiles). The geographic location and the time that the photograph is taken, using GPS coordinates and time or manually entered coordinates or time, the firmware 13 determine preferred parameters for the scene that is to be photographed.

Thus, by knowing the geographic location (either using GPS coordinates or manually entered coordinates or a location) and the time that the photograph is taken (again using GPS time or a manually entered time) firmware running on the camera can determine preferred parameters for the scene that is to be photographed. Using the location and time information, the firmware 13 eliminates those stored scene types (scene profiles) that are not appropriate for the location and/or time. The firmware 13 then determines or selects an optimal scene profile and scene parameters from the remaining scene types or profiles and configures the digital camera 10.

By way of example, every camera manufacturer has their own concept of what the illumination source and scene profiles look like. More precisely, each camera manufacturer has an algorithm by which they use the expected illumination source to impact how they modify the colors that come off of the image sensor 11. What is possible using the present invention, however, is to have a “global profile” (that tries to minimize errors across all possible type of color that could be in a picture), and then modify this. By way of example, if one is in the Caribbean, the water is known to have an aqua-green color. Rather than minimize the error, the global profile may be changes to “maximize” the representation of aqua-green colors (water). This type of “color balancing” (minimizing error across all color representations) is well-known in the art.

An advantage provided by this second aspect of the present invention is that the selected scene profile is more accurate than in cameras that do not allow the user to input scene selection criteria. Also, this aspect simplifies or removes the portion of the user interface for cameras that allow the user to select the scene type prior to pressing the shutter and taking the photograph.

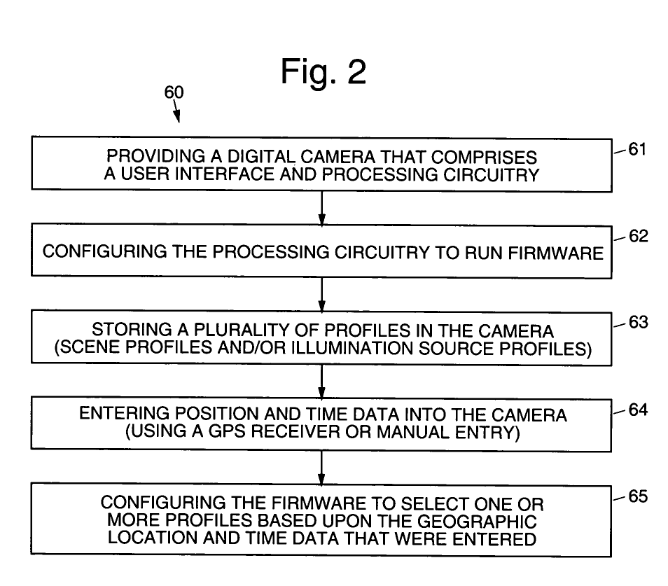

FIG. 2 illustrates an exemplary method 60 in accordance with the principles of the present invention. The exemplary method 60 comprises the following steps.

A digital camera 10 is provided 61 that comprises a user interface 18 and processing circuitry 12. The processing circuitry is configured 62 to run firmware 13. A plurality of scene profiles are stored 63 in the camera. The profiles may be a plurality of scene profiles and/or a plurality of illumination source profiles. The user interface is used to enter 64 position data (position coordinates) and time data into the camera. Position and time data may be entered 64 using a GPS receiver 16 or may be manually entered 64. The firmware 13 is configured 65 to select one or more profiles, such as a scene profile (parameters) and/or an illumination source profile based upon the geographic location and time data that were entered, typically the time and location that the photograph is to be taken.

Thus, digital cameras and methods have been disclosed that employ location and time data to automatically select and adjust scene parameters and illumination source profiles used when taking photographs at different geographic locations. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A digital camera comprising:
a user interface;
processing circuitry coupled to the user interface;
a plurality of predetermined profiles stored in the camera; and
firmware that runs on the processing circuitry that processes geographic location and time data entered into the camera to select one of the profiles based upon the geographic location and time data.

2. The digital camera recited in claim 1 wherein the plurality of profiles comprise a plurality of scene profiles.

3. The digital camera recited in claim 1 wherein the plurality of profiles comprise a plurality of illumination source profiles.

4. The digital camera recited in claim 1 wherein the plurality of profiles comprise a plurality of scene profiles and a plurality of illumination source profiles.

5. The digital camera recited in claim 1 further comprising a GPS receiver and wherein the geographic location and time data are entered from said GPS receiver.

6. The digital camera recited in claim 1 wherein the geographic location and time data are manually entered by way of the user interface.

7. The digital camera recited in claim 2 wherein the firmware is configured to select a scene profile.

8. The digital camera recited in claim 3 wherein the firmware is configured to select an illumination profile.

9. A method comprising the steps of;
providing a digital camera that comprises a user interface and processing circuitry;
configuring the processing circuitry to run firmware;
storing a plurality of profiles in the camera;
entering geographic location and time data into the camera; and
configuring the firmware to select one of the profiles based upon the geographic location and time data that were entered.

10. The method recited in claim 9 wherein the plurality of profiles comprise a plurality of scene profiles.

11. The method recited in claim 9 wherein the plurality of profiles comprise a plurality of illumination source profiles.

12. The method recited in claim 9 wherein the plurality of profiles comprise a plurality of scene profiles and a plurality of illumination source profiles.

13. The method recited in claim 9 wherein the geographic location and time data are entered using a GPS receiver.

14. The method recited in claim 9 wherein the geographic location and time data are manually entered.

15. The method recited in claim 10 wherein the firmware is configured to select a scene profile.

16. The method recited in claim 11 wherein the firmware is configured to select an illumination profile.

17. A method comprising the steps of;
providing a digital camera that comprises a user interface, a plurality of stored profiles, and processing circuitry that is configured to run firmware that is responsive to geographic location and time data;
entering geographic location and time data into the camera; and
selecting, by way of the firmware, one of the profiles based upon the geographic location and time data that were entered.

18. The method recited in claim 17 wherein the geographic location and time data are entered using a GPS receiver.

19. The method recited in claim 17 wherein the geographic location and time data are manually entered.
